(19) United States
(12) Patent Application Publication
(10) Pub. No.: US 2023/0231580 A1
(43) Pub. Date: Jul. 20, 2023

(54) COMMUNICATION CIRCUIT FOR PERFORMING COMMUNICATION USING A PLURALITY OF FREQUENCY BANDS, AND ELECTRONIC DEVICE COMPRISING SAME

(71) Applicant: SAMSUNG ELECTRONICS CO., LTD., Suwon-si (KR)

(72) Inventors: Dongil YANG, Suwon-si (KR); Taeyoung KIM, Suwon-si (KR); Jonghun YOO, Suwon-si (KR); Woonyun KIM, Suwon-si (KR); Hyoseok NA, Suwon-si (KR)

(73) Assignee: SAMSUNG ELECTRONICS CO., LTD., Suwon-si (KR)

(21) Appl. No.: 18/114,796

(22) Filed: Feb. 27, 2023

Related U.S. Application Data
(63) Continuation of application No. PCT/KR2021/010853, filed on Aug. 17, 2021.

(30) Foreign Application Priority Data
Aug. 26, 2020 (KR) 10-2020-0107812

(51) Int. Cl. H04B 1/00; H04B 1/401

(52) U.S. Cl. CPC H04B 1/006; H04B 1/401

(57) ABSTRACT

A communication circuit includes: a first radio frequency (RF) chain configured to output and/or receive a signal of a first frequency band through an antenna port; a second RF chain configured to output and/or receive a signal of a second frequency band through the antenna port; and a switch comprising a first terminal electrically connected to the first RF chain, a second terminal electrically connected to the second RF chain, and a third terminal electrically connected to a ground. The switch is configured to operate in a first operation mode or a second operation mode. In the first operation mode, the first terminal is electrically connected to the second terminal. In the second operation mode, the first terminal is electrically connected to the third terminal.

### CROSS-REFERENCE TO RELATED APPLICATIONS

This application is a continuation application of International Application No. PCT/KR2021/010853, filed on Aug. 17, 2021, which claims priority to Korean Patent Application No. 10-2020-0107812 filed on Aug. 26, 2020 in the Korean Intellectual Property Office, the disclosures of which are herein incorporated by reference.

### TECHNICAL FIELD

Various embodiments of the disclosure relate to a communication circuit and an electronic device that perform communication using a plurality of frequency bands.

### BACKGROUND

Various electronic devices such as a smartphone, tablet personal computer (tablet PC), portable multimedia player (PMP), personal digital assistant (PDA), laptop PC or wearable device have come into wide use.

Recently, electronic devices may support a communication scheme using multiple frequency bands (e.g., dual connectivity or carrier aggregation). A communication scheme using plural frequency bands may have a larger frequency bandwidth compared to a communication scheme using a single frequency band. A communication scheme using plural frequency bands and having a relatively large frequency bandwidth can implement a higher data transmission or reception rate compared to other communication schemes.

To support a communication scheme using a plurality of frequency bands, an electronic device may include plural RF chains between the antenna and the transceiver to process signals of the individual frequency bands. To separate signals of plural frequency bands and transfer them to corresponding RF chains, the electronic device may include a filter between the antenna and the RF chains for separating signals according to the frequency bands.

### SUMMARY

Various electronic devices such as a smartphone, tablet personal computer (tablet PC), portable multimedia player (PMP), personal digital assistant (PDA), laptop PC or wearable device have come into wide use.

Recently, electronic devices may support a communication scheme using multiple frequency bands (e.g., dual connectivity or carrier aggregation). A communication scheme using plural frequency bands may have a larger frequency bandwidth compared to a communication scheme using a single frequency band. A communication scheme using plural frequency bands and having a relatively large frequency bandwidth can implement a higher data transmission or reception rate compared to other communication schemes.

To support a communication scheme using plural frequency bands, an electronic device may include a plurality of RF chains between the antenna and the transceiver to process signals of the individual frequency bands. To separate signals of plural frequency bands and transfer them to corresponding RF chains, the electronic device may include a filter between the antenna and the RF chains for separating signals according to the frequency bands.

A communication circuit may include: a first radio frequency (RF) chain configured to output and/or receive a signal of a first frequency band through an antenna port; a second RF chain configured to output and/or receive a signal of a second frequency band through the antenna port; and a switch comprising a first terminal electrically connected to the first RF chain, a second terminal electrically connected to the second RF chain, and a third terminal electrically connected to a ground. The switch may be configured to operate in a first operation mode or a second operation mode. In the first operation mode, the first terminal may be electrically connected to the second terminal. In the second operation mode, the first terminal may be electrically connected to the third terminal.

The first operation mode may be an operation mode where the signal of the first frequency band and the signal of the second frequency band can be simultaneously transmitted or received.

The second operation mode may be an operation mode where the signal of the first frequency band can be transmitted or received and the signal of the second frequency band cannot be transmitted or received.

The communication circuit may further include a matching circuit electrically connected between the third terminal and the ground, the matching circuit being configured so as to prevent a signal to be transmitted or received through the first RF chain from being transferred to the second terminal or the third terminal in the first operation mode.

The communication circuit may further include a first filter configured to block a signal of the second frequency band, the first filter being electrically connected between the first RF chain and the antenna port.

The communication circuit may further include a second filter configured to block a signal of the first frequency band, the second filter being electrically connected between the second RF chain and the switch.

A communication circuit may include: a first radio frequency (RF) chain configured to output and/or receive a signal of a first frequency band through an antenna port; a second RF chain configured to output and/or receive a signal of a second frequency band through the antenna port; a first switch comprising a first terminal electrically connected to the first RF chain, a second terminal electrically connected to the antenna port, and a third terminal electrically connected to a ground; and a second switch comprising a fourth terminal electrically connected to the second RF chain, a fifth terminal connected to the antenna port, and a sixth terminal electrically connected to the ground. The communication circuit may be configured to operate in a first operation mode, a second operation mode, or a third operation mode. In the first operation mode, the first terminal may be electrically connected to the second terminal and the fourth terminal may be electrically connected to the fifth terminal. In the second operation mode, the first terminal may be electrically connected to the second terminal and the fifth terminal may be electrically connected to the sixth terminal. In the third operation mode, the second terminal may be electrically connected to the third terminal and the fourth terminal may be electrically connected to the fifth terminal.

The first operation mode may be an operation mode where the signal of the first frequency band and the signal of the second frequency band can be simultaneously transmitted or received through the antenna port.

The second operation mode may be an operation mode where the signal of the first frequency band can be transmitted or received through the antenna port and the signal of the second frequency band cannot be transmitted or received through the antenna port.

The third operation mode may be an operation mode where a signal of the second frequency band can be transmitted or received through the antenna port and the signal of the first frequency band cannot be transmitted or received through the antenna port.

The communication circuit may further include a first matching circuit electrically connected between the third terminal and the ground, the first matching circuit being configured so as to prevent a signal to be transmitted or received through the second RF chain from being transferred to the first terminal or the third terminal in the third operation mode.

The communication circuit may further include a second matching circuit electrically connected between the sixth terminal and the ground, the second matching circuit being configured so as to prevent a signal to be transmitted or received through the first RF chain from being transferred to the fourth terminal or the sixth terminal in the second operation mode.

The communication circuit may be configured to operate in the first operation mode, the second operation mode, the third operation mode, or a fourth operation mode. In the fourth operation mode, the second terminal may be electrically connected to the third terminal and the fifth terminal may be electrically connected to the sixth terminal. The fourth operation mode may be a mode where neither the signal of the first frequency band nor the signal of the second frequency band can be transmitted or received through the antenna port.

The first switch may further include a seventh terminal electrically connected to the ground. The second switch may further include an eighth terminal electrically connected to the ground. The communication circuit may be configured to operate in the first operation mode, the second operation mode, the third operation mode, the fourth operation mode, or a fifth operation mode. In the fifth operation mode, the second terminal may be electrically connected to the seventh terminal and the fifth terminal may be electrically connected to the eighth terminal.

An electronic device may include: a communication processor; a transceiver; and a communication circuit. The communication circuit may include: a first radio frequency (RF) chain configured to output and/or receive a signal of a first frequency band through an antenna port, a second RF chain configured to output and/or receive a signal of a second frequency band through the antenna port, and a switch comprising a first terminal electrically connected to the first RF chain, a second terminal electrically connected to the second RF chain, and a third terminal electrically connected to a ground. The communication processor may be configured to: control the switch to electrically connect the first terminal to the second terminal in a first operation mode where the signal of the first frequency band and the signal of the second frequency band can be simultaneously transmitted or received, and control the switch to electrically connect the first terminal to the third terminal in a second operation mode where the signal of the first frequency band can be transmitted or received and the signal of the second frequency band cannot be transmitted or received.

In the first operation mode, the first terminal may not be electrically connected to the third terminal. In the second operation mode, the first terminal may not be electrically connected to the second terminal.

In the first operation mode, the second terminal may not be electrically connected to the third terminal and the sixth terminal may not be electrically connected to the fifth terminal. In the second operation mode, the second terminal may not be electrically connected to the third terminal and the fifth terminal may not be electrically connected to the fourth terminal. In the third operation mode, the second terminal may not be electrically connected to the first terminal and the sixth terminal may not be electrically connected to the fifth terminal.

The communication circuit may further include a first matching circuit electrically connected between the third terminal and the ground, the first matching circuit being configured so as to prevent a signal to be transmitted or received through the second RF chain from being transferred to the first terminal or the third terminal in the third operation mode, and a second matching circuit electrically connected between the sixth terminal and the ground, the second matching circuit being configured so as to prevent a signal to be transmitted or received through the first RF chain from being transferred to the fourth terminal or the sixth terminal in the second operation mode.

The communication circuit may further include a third matching circuit electrically connected between the third terminal and the ground and between the sixth terminal and the ground, the third matching circuit being configured so as (i) to prevent a signal to be transmitted or received through the second RF chain from being transferred to the first terminal or the third terminal in the third operation mode and (ii) to prevent a signal to be transmitted or received through the first RF chain from being transferred to the fourth terminal or the sixth terminal in the second operation mode.

In the first operation mode, the first terminal may not be electrically connected to the third terminal. In the second operation mode, the first terminal may not be electrically connected to the second terminal.

According to various embodiments of the disclosure, the communication circuit and the electronic device including the same may perform signal separation by using a switch between the antenna and RF chains. Since, unlike a filter, the switch is not differently implemented according to the frequency band, the manufacturing cost of the electronic device can be reduced.

According to various embodiments of the disclosure, the communication circuit and the electronic device including the same may support communication mode for one of an operation mode using plural frequency bands (carrier aggregation or dual connectivity mode) and an operation mode using a single frequency band (stand-alone mode) based on the communication processor controlling the switch. Accordingly, the communication circuit and the electronic device including the same can easily change the communication mode.

According to various embodiments of the disclosure, in the communication mode using one frequency band, the communication circuit and the electronic device including the same may control the switch to cut off the connection between an RF chain for processing another frequency band and the antenna, so that it is possible to prevent a signal from being transferred to the RF chain for processing another frequency band. Hence, the communication circuit and the electronic device including the same can reduce unnecessary signal loss in the communication mode using one frequency band.

In addition, other effects that can be obtained or predicted due to various embodiments of the disclosure may be directly or indirectly disclosed in the detailed description of the embodiments of the disclosure.

### BRIEF DESCRIPTION OF DRAWINGS

FIG. 1 is a block diagram of an electronic device according to various embodiments of the disclosure.

FIG. 2 is a block diagram of an electronic device for supporting legacy network communication and 5G network communication according to various embodiments.

FIG. 3 is a block diagram of an electronic device according to various embodiments of the disclosure.

FIG. 4 is a diagram illustrating a communication circuit of the electronic device according to various embodiments of the disclosure.

FIGS. 5A and 5B are diagrams depicting operations of the switch for first operation mode and second operation mode in the communication circuit of the electronic device according to various embodiments of the disclosure.

FIG. 6 is a diagram illustrating a communication circuit of the electronic device according to various embodiments of the disclosure.

FIG. 7 is a diagram illustrating a communication circuit of the electronic device according to various embodiments of the disclosure.

FIGS. 8A, 8B, 8C and 8D are diagrams depicting operations of the switch for first operation mode, second operation mode, third operation mode, and fourth operation mode in the communication circuit of the electronic device according to various embodiments of the disclosure.

FIG. 9 is a diagram depicting operations of the switch for fourth operation mode in the communication circuit of the electronic device according to various embodiments of the disclosure.

### DETAILED DESCRIPTION

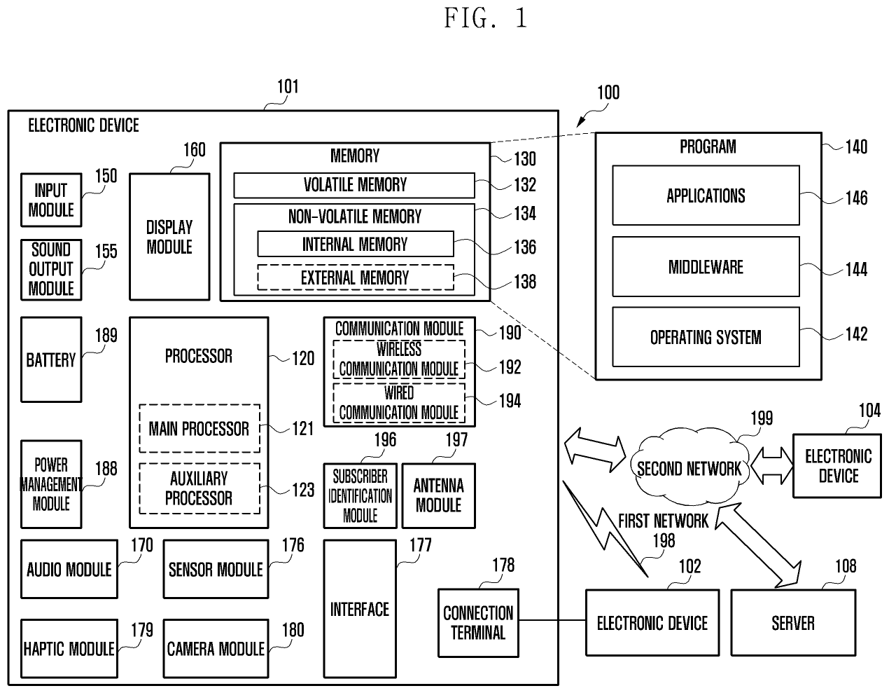

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

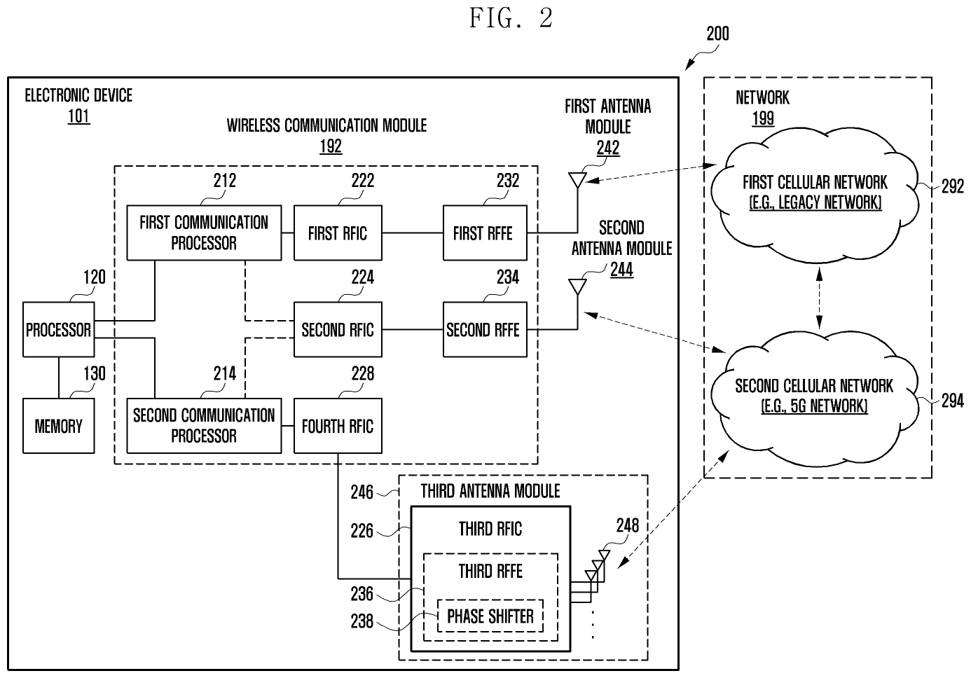

FIG. 2 is a block diagram illustrating an electronic device in a network environment including a plurality of cellular networks according to an embodiment of the disclosure. Referring to FIG. 2, the electronic device 101 may include a first communication processor 212, second communication processor 214, first RFIC 222, second RFIC 224, third RFIC 226, fourth RFIC 228, first radio frequency front end (RFFE) 232, second RFFE 234, first antenna module 242, second antenna module 244, and antenna 248. The electronic device 101 may include a processor 120 and a memory 130. A second network 199 may include a first cellular network 292 and a second cellular network 294. According to another embodiment, the electronic device 101 may further include at least one of the components described with reference to FIG. 1, and the second network 199 may further include at least one other network. According to one embodiment, the first communication processor 212, second communication processor 214, first RFIC 222, second RFIC 224, fourth RFIC 228, first RFFE 232, and second RFFE 234 may form at least part of the wireless communication module 192. According to another embodiment, the fourth RFIC 228 may be omitted or included as part of the third RFIC 226.

The first communication processor 212 may establish a communication channel of a band to be used for wireless communication with the first cellular network 292 and support legacy network communication through the established communication channel. According to various embodiments, the first cellular network may be a legacy network including a second generation (2G), 3G, 4G, or long term evolution (LTE) network. The second communication processor 214 may establish a communication channel corresponding to a designated band (e.g., about 6 GHz to about 60 GHz) of bands to be used for wireless communication with the second cellular network 294, and support fifth generation (5G) network communication through the established communication channel. According to various embodiments, the second cellular network 294 may be a 5G network defined in 3rd generation partnership project (3GPP). Additionally, according to an embodiment, the first communication processor 212 or the second communication processor 214 may establish a communication channel corresponding to another designated band (e.g., about 6 GHz or less) of bands to be used for wireless communication with the second cellular network 294 and support 5G network communication through the established communication channel. According to one embodiment, the first communication processor 212 and the second communication processor 214 may be implemented in a single chip or a single package. According to various embodiments, the first communication processor 212 or the second communication processor 214 may be formed in a single chip or a single package with the processor 120, the auxiliary processor 123, or the communication module 190.

Upon transmission, the first RFIC 222 may convert a baseband signal generated by the first communication processor 212 to a radio frequency (RF) signal of about 700 MHz to about 3 GHz used in the first cellular network 292 (e.g., legacy network). Upon reception, an RF signal may be obtained from the first cellular network 292 (e.g., legacy network) through an antenna (e.g., the first antenna module 242) and be preprocessed through an RFFE (e.g., the first RFFE 232). The first RFIC 222 may convert the preprocessed RF signal to a baseband signal so as to be processed by the first communication processor 212.

Upon transmission, the second RFIC 224 may convert a baseband signal generated by the first communication processor 212 or the second communication processor 214 to an RF signal (hereinafter, 5G Sub6 RF signal) of a Sub6 band (e.g., 6 GHz or less) to be used in the second cellular network 294 (e.g., 5G network). Upon reception, a 5G Sub6 RF signal may be obtained from the second cellular network 294 (e.g., 5G network) through an antenna (e.g., the second antenna module 244) and be pretreated through an RFFE (e.g., the second RFFE 234). The second RFIC 224 may convert the preprocessed 5G Sub6 RF signal to a baseband signal so as to be processed by a corresponding communication processor of the first communication processor 212 or the second communication processor 214.

The third RFIC 226 may convert a baseband signal generated by the second communication processor 214 to an RF signal (hereinafter, 5G Above6 RF signal) of a 5G Above6 band (e.g., about 6 GHz to about 60 GHz) to be used in the second cellular network 294 (e.g., 5G network). Upon reception, a 5G Above6 RF signal may be obtained from the second cellular network 294 (e.g., 5G network) through an antenna (e.g., the antenna 248) and be preprocessed through the third RFFE 236. The third RFIC 226 may convert the preprocessed 5G Above6 RF signal to a baseband signal so as to be processed by the second communication processor 214. According to one embodiment, the third RFFE 236 may be formed as part of the third RFIC 226.

According to an embodiment, the electronic device 101 may include a fourth RFIC 228 separately from the third RFIC 226 or as at least part of the third RFIC 226. In this case, the fourth RFIC 228 may convert a baseband signal generated by the second communication processor 214 to an RF signal (hereinafter, an intermediate frequency (IF) signal) of an intermediate frequency band (e.g., about 9 GHz to about 11 GHz) and transfer the IF signal to the third RFIC 226. The third RFIC 226 may convert the IF signal to a 5G Above 6RF signal. Upon reception, the 5G Above 6RF signal may be received from the second cellular network 294 (e.g., a 5G network) through an antenna (e.g., the antenna 248) and be converted to an IF signal by the third RFIC 226. The fourth RFIC 228 may convert an IF signal to a baseband signal so as to be processed by the second communication processor 214.

According to one embodiment, the first RFIC 222 and the second RFIC 224 may be implemented into at least part of a single package or a single chip. According to one embodiment, the first RFFE 232 and the second RFFE 234 may be implemented into at least part of a single package or a single chip. According to one embodiment, at least one of the first antenna module 242 or the second antenna module 244 may be omitted or may be combined with another antenna module to process RF signals of a corresponding plurality of bands.

According to one embodiment, the third RFIC 226 and the antenna 248 may be disposed at the same substrate to form a third antenna module 246. For example, the wireless communication module 192 or the processor 120 may be disposed at a first substrate (e.g., main PCB). In this case, the third RFIC 226 is disposed in a partial area (e.g., lower surface) of the first substrate and a separate second substrate (e.g., sub PCB), and the antenna 248 is disposed in another partial area (e.g., upper surface) thereof; thus, the third antenna module 246 may be formed. By disposing the third RFIC 226 and the antenna 248 in the same substrate, a length of a transmission line therebetween can be reduced. This may reduce, for example, a loss (e.g., attenuation) of a signal of a high frequency band (e.g., about 6 GHz to about 60 GHz) to be used in 5G network communication by a transmission line. Therefore, the electronic device 101 may improve a quality or speed of communication with the second cellular network 294 (e.g., 5G network).

According to one embodiment, the antenna 248 may be formed in an antenna array including a plurality of antenna elements that may be used for beamforming. In this case, the third RFIC 226 may include a plurality of phase shifters 238 corresponding to a plurality of antenna elements, for example, as part of the third RFFE 236. Upon transmission, each of the plurality of phase shifters 238 may convert a phase of a 5G Above6 RF signal to be transmitted to the outside (e.g., a base station of a 5G network) of the electronic device 101 through a corresponding antenna element. Upon reception, each of the plurality of phase shifters 238 may convert a phase of the 5G Above6 RF signal received from the outside to the same phase or substantially the same phase through a corresponding antenna element. This enables transmission or reception through beamforming between the electronic device 101 and the outside.

The second cellular network 294 (e.g., 5G network) may operate (e.g., stand-alone (SA)) independently of the first cellular network 292 (e.g., legacy network) or may be operated (e.g., non-stand alone (NSA)) in connection with the first cellular network 292. For example, the 5G network may have only an access network (e.g., 5G radio access network (RAN) or a next generation (NG) RAN and have no core network (e.g., next generation core (NGC)). In this case, after accessing to the access network of the 5G network, the electronic device 101 may access to an external network (e.g., Internet) under the control of a core network (e.g., an evolved packed core (EPC)) of the legacy network. Protocol information (e.g., LTE protocol information) for communication with a legacy network or protocol information (e.g., new radio (NR) protocol information) for communication with a 5G network may be stored in the memory 130 to be accessed by other components (e.g., the processor 120, the first communication processor 212, or the second communication processor 214).

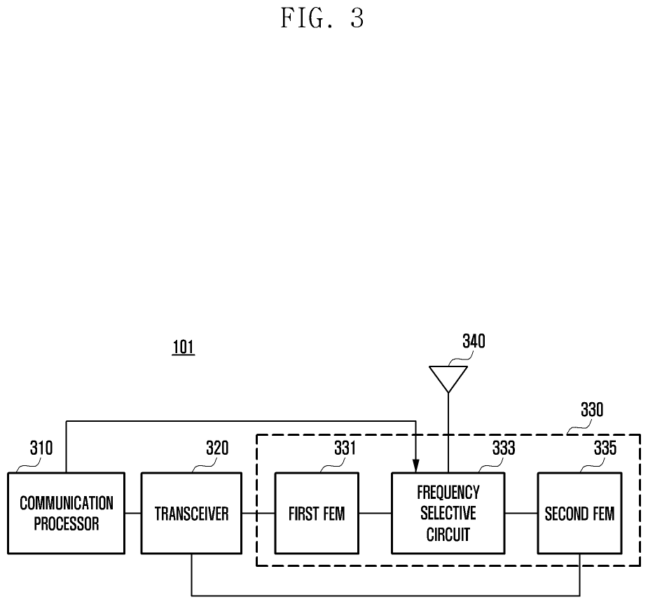

FIG. 3 is a block diagram of an electronic device according to various embodiments of the disclosure.

With reference to FIG. 3, the electronic device (e.g., electronic device 101 in FIG. 1) according to various embodiments of the disclosure may include a communication processor 310 (e.g., first communication processor 212 in FIG. 2 or second communication processor 214 in FIG. 2), a transceiver 320 (e.g., first RFIC 222, second RFIC 224, or fourth RFIC 228 in FIG. 2), a communication circuit 330, and/or an antenna 340 (e.g., first antenna module 242, second antenna module 244, or third antenna module 246 in FIG. 2).

The communication processor 310 may receive or transmit control data or user data through short-range wireless communication (e.g., Wi-Fi or Bluetooth) or cellular wireless communication (e.g., 4^{th} generation mobile communication or 5^{th} generation mobile communication). The communication processor 310 may establish a cellular communication connection to a base station by using control data, and may, through the established cellular communication, transmit data received from the application processor (e.g., processor 120 in FIG. 1) to the base station or transmit data received from the base station to the application processor 120.

The transceiver 320 may perform various operations for processing signals received from the communication processor 310. For example, the transceiver 320 may perform a modulation operation on a signal received from the communication processor 310. For example, the transceiver 320 may perform a frequency modulation operation to convert a baseband signal into a radio frequency (RF) signal used for cellular communication. The transceiver 320 may also perform a demodulation operation on a signal received from the outside through the communication circuit 330. For example, the transceiver 320 may perform a frequency demodulation operation to convert a radio frequency (RF) signal into a baseband signal.

The communication circuit 330 may include at least two RF chains to receive a signal radiated from the outside through the antenna 340 or to radiate a signal received from the transceiver 320 through the antenna 340. For example, the RF chain may refer to a signal transfer path between the communication circuit 330 and the antenna 340. The RF chain may include various components (e.g., amplifier, switch, filter) that amplify a signal received through the antenna 340 and/or a signal transferred by the transceiver 320 and filter the amplified signals.

The communication circuit 330 may include at least two RF chains to support a communication scheme using at least two frequency bands. For example, the communication circuit 330 may support dual connectivity being a data communication scheme through different cellular communication modes (e.g., 4G cellular communication and 5G cellular communication), or carrier aggregation being a data communication scheme using plural frequency bands. To this end, the communication circuit 330 may include a first front end module (FEM) 331 that outputs a signal of the first frequency band through the antenna 340 or receives a signal of the first frequency band through the antenna 340, and/or a second FEM 333 that outputs a signal of the second frequency band through the antenna 340 or receives a signal of the second frequency band through the antenna 340. The communication circuit 330 may transmit or receive a signal through the first FEM 331 and/or the second FEM 333 by using the antenna 340 in common. According to an embodiment, the first FEM 331 may include a first RF chain capable of transmitting a signal of a first frequency band. As another example, the second FEM 335 may include a second RF chain capable of transmitting a signal of a second frequency band. As another example, the first FEM 331 or the second FEM 335 may include a first RF chain capable of transmitting a signal of a first frequency band, and a second RF chain capable of transmitting a signal of a second frequency band.

In FIG. 3, the communication circuit 330 is shown as including two FEMs, but a plurality of FEMs may be included according to simultaneous transmission or reception of signals through different frequency bands supported by the communication circuit 330. For example, the communication circuit 330 may include three FEMs to support frequency division duplexing (FDD) using signals in all three frequency bands (e.g., band B1 (1920 to 1980 MHz), band B2 (1850 to 1910 MHz), and band B3 (1710 to 1785 MHz)). As another example, the communication circuit 330 may include a single FEM (e.g., first FEM 331), and this FEM may include a plurality of RF chains capable of supporting different frequency bands.

The communication circuit 330 may include a frequency branch circuit 333 for separating signals received through the antenna 340. The frequency branch circuit 333 may transfer a signal of the first frequency band received through the antenna 340 to the first FEM 331, and may transfer a signal of the second frequency band received through the antenna 340 to the second FEM 333.

The frequency branch circuit 333 may be a multiplexer or extractor implemented as a combination of a band pass filter (BPF) that passes only a signal of a specific frequency band, a band reject filter (BRF) that blocks a signal of a specific frequency band, and/or a diplexer that splits a signal of a frequency band higher than a set frequency and a signal of a frequency band lower than the set frequency. When the frequency branch circuit 333 is implemented as a combination of filters, additional components (e.g., BPF or BRF) are required in order to use signals of additional frequency bands; and as the number of supported frequency bands increases, the number of components increases, so the manufacturing cost of the communication circuit 330 may increase and the size of the communication circuit 330 may increase. Further, when the frequency branch circuit 333 is implemented as a combination of filters, to use a signal of an additional frequency band, the design of the frequency selective circuit may need to be changed to support the signal of the additional frequency band.

The antenna 340 may include a broadband antenna capable of supporting plural frequency bands.

Next, a description will be given of embodiments of the communication circuit 330 that performs communication using signals of multiple frequency bands without changing the design of the frequency branch circuit 333 through implementation of the frequency branch circuit 333 using a switch.

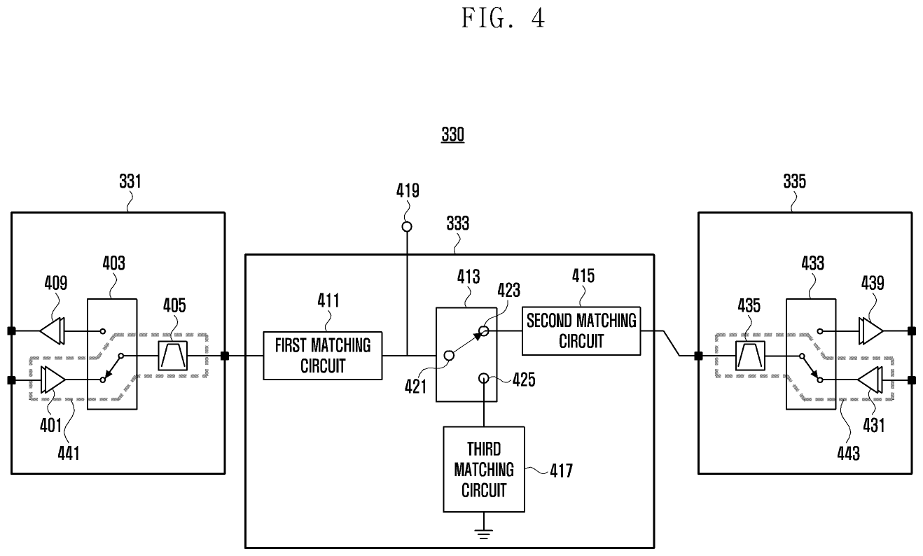

FIG. 4 is a diagram illustrating a communication circuit of the electronic device according to various embodiments of the disclosure.

With reference to FIG. 4, the communication circuit (e.g., communication circuit 330 in FIG. 3) according to various embodiments of the disclosure may include a first FEM 331, a frequency branch circuit 333, and/or a second FEM 335.

The first FEM 331 may amplify and filter a signal of the first frequency band to be output through the antenna (e.g., antenna 340 in FIG. 3), or may amplify and filter a signal of the first frequency band received through the antenna 340. The first FEM 331 may include a first amplifier 401 for amplifying a signal received from the transceiver (e.g., transceiver 320 in FIG. 3), a switch 403 for transferring the amplified signal to a filter 405, the filter 405 that passes a signal of a specific frequency band, and/or a third amplifier 409 for amplifying a signal of the first frequency band received through the antenna 340. The third amplifier 409 may be implemented with a low-noise amplifier.

The first FEM 331 may perform an operation under the control of the communication processor (e.g., communication processor 310 in FIG. 3). The communication processor 310 may control the switch 403 so that the filter 405 and the first amplifier 401 are connected in correspondence to the frequency band in use. The communication processor 310 may control the switch (not shown) so that the filter 405 and the frequency selective circuit 333 are connected in correspondence to the frequency band in use. The first FEM 331 may process a signal transferred by the transceiver 320 and radiate the processed signal through the antenna 340 electrically connected to the antenna port 419. According to an embodiment, the antenna port 419 may be electrically connected to a path branched out from an electrical path connecting the first FEM 331 and the frequency selective circuit 333. For example, the antenna port 419 may be electrically connected to a location of an electrical path connecting the first FEM 331 and the first terminal 421.

The first FEM 331 may include a first RF chain 441 capable of transferring a signal of the first frequency band. The first RF chain 441 may include one or more components (e.g., amplifier 401, switch 403, and/or filter 405) for transferring a signal of the first frequency band.

In FIG. 4, although one RF chain (e.g., first RF chain 441) is shown, the number of RF chains may be varied according to the number of frequency bands supported by the first FEM 331. When the number of frequency bands supported by the first FEM 331 is plural, a switch may be implemented between one of the plural RF chains and the frequency branch circuit 333.

The second FEM 335 may amplify and filter a signal of the second frequency band to be output through the antenna (e.g., antenna 340 in FIG. 3), or may amplify and filter a signal of the second frequency band received through the antenna 340. The second FEM 335 may include a second amplifier 431 for amplifying a signal received from the transceiver (e.g., transceiver 320 in FIG. 3), a switch 433 for transferring the amplified signal to a filter 435, the filter 435 that passes a signal of a specific frequency band, and/or a fourth amplifier 439 for amplifying a signal of the second frequency band received through the antenna 340.

The second FEM 335 may include a second RF chain 443 capable of transferring a signal of the second frequency band. The second RF chain 443 may include one or more components (e.g., amplifier 431, switch 433, and/or filter 435) for transferring a signal of the second frequency band.

In FIG. 4, although one RF chain (e.g., second RF chain 443) is shown, the number of filters 435 may be varied according to the number of frequency bands supported by the second FEM 335. When the number of frequency bands supported by the second FEM 335 is plural, a switch connecting one of the plural filters 435 and the frequency branch circuit 333 may be implemented.

The frequency branch circuit 333 may include a switch 413 that controls paths of a signal of the first frequency band and a signal of the second frequency band. The switch 413 may include a first terminal 421 electrically connected to the first FEM 331, a second terminal 423 electrically connected to the second FEM 335, and a third terminal 425 electrically connected to the ground.

The communication processor 310 may support at least two operation modes. The communication processor 310 may support a first operation mode in which a signal of the first frequency band and a signal of the second frequency band can be simultaneously transmitted or received, a second operation mode in which a signal of the first frequency band can be transmitted or received, and a third operation mode in which a signal of the second frequency band can be transmitted or received. The communication processor 310 may select one of the first operation mode and the second operation mode based on control data received from the base station (not shown), and control the switch 413 according to the selected operation mode.

The communication processor 310 may operate in the first operation mode based on control data received from the base station. As the communication processor 310 operates in the first operation mode, it may control the switch 413 to electrically connect the first terminal 421 and the second terminal 423. When the first terminal 421 and the second terminal 423 are electrically connected, signals received by the antenna 340 may be transferred to the first FEM 331 and the second FEM 335. Some of the signals received by the antenna 340 may be transferred to the filter 405 through the switch 413, and a signal corresponding to the first frequency band among the signals received by the antenna 340 may be transferred to the transceiver 320 through the filter 405, the switch 403, and the third amplifier 409. Among the signals received by the antenna 340, a signal not belonging to the first frequency band may be blocked by the filter 405. Some of the other signals received by the antenna 340 may be transferred to the second FEM 335 through the switch 413. Among some of the other signals received by the antenna 340, a signal of the second frequency band may be transferred to the transceiver 320 through the second FEM 335, and a signal not belonging to the second frequency band may be blocked by the second FEM 335.

The communication processor 310 may operate in the second operation mode based on control data received from the base station. As the communication processor 310 operates in the second operation mode, it may control the switch 413 to electrically connect the first terminal 421 and the third terminal 425. When the first terminal 421 and the third terminal 425 are electrically connected, the signal received by the antenna 340 may be transferred to the first FEM 331. Some of the signals received by the antenna 340 may be transferred to the filter 405 through the switch 413, and a signal corresponding to the first frequency band among the signals received by the antenna 340 may be transferred to the transceiver 320 through the filter 405, the switch 403, and the third amplifier 409. The second terminal 423 may be in a state not connected to the first terminal 421, in which case a signal of the second frequency band may be not transferred to the transceiver 320.

The communication processor 310 may operate in the third operation mode based on control data received from the base station. As the communication processor 310 operates in the third operation mode, it may control the first switch 413 to electrically connect the first terminal 421 and the second terminal 423. When the first terminal 421 and the second terminal 423 are electrically connected, the signal received by the antenna 340 may be transferred to the first FEM 331 or the second FEM 335. Among the signals received by the antenna 340, a signal of the first frequency band may be filtered by the first FEM 331 and transferred to the transceiver 320. Among the signals received by the antenna 340, a signal of the second frequency band may be filtered by the second FEM 335 and transferred to the transceiver 320.

The first FEM 331 may perform an operation under the control of the communication processor (e.g., communication processor 310 in FIG. 3). The communication processor 310 may control the switch 403 so that the filter 405 is connected to the first amplifier 401 or the second amplifier 409 based on a transmission operation or reception operation. When the first FEM 331 implements plural RF chains (e.g., first RF chain 441), the communication processor 310 may control the switch 403 to connect an RF chain (e.g., first RF chain 441) corresponding to the frequency band in use and the frequency selective circuit 333. The first FEM 331 may process a signal transferred by the transceiver 320 and radiate the processed signal through the antenna port 419 and the antenna 340. In this case, the communication circuit 330 may be operating in the second operation mode or the third operation mode.

The second FEM 335 may perform an operation under the control of the communication processor (e.g., communication processor 310 in FIG. 3). The communication processor 310 may control the switch 433 so that the filter 435 is connected to the second amplifier 431 or the fourth amplifier 439 based on a transmission operation or reception operation. When the second FEM 335 implements plural RF chains (e.g., second RF chain 443), the communication processor 310 may control the switch 433 to connect an RF chain (e.g., second RF chain 443) corresponding to the frequency band in use and the frequency selective circuit 333. The second FEM 335 may process a signal transferred by the transceiver 320 and radiate the processed signal through the second terminal 423, the antenna port 419 and the antenna 340. In this case, the switch 413 of the frequency selective circuit 333 may be in a state where the first terminal 421 and the second terminal 423 are electrically connected, and the communication circuit 330 may be operating in the first operation mode or the third operation mode.

The frequency branch circuit 333 may include a first matching circuit 411 performing impedance matching between the antenna 340 and the first FEM 331, a second matching circuit 415 performing impedance matching between the antenna 340 and the second FEM 335, and/or a third matching circuit 417.

The third matching circuit 417 may be electrically connected between the third terminal 425 and the ground. The third matching circuit 417 may be a circuit that performs impedance matching for the first frequency band in the second operation mode. The third matching circuit 417 may perform impedance matching between the antenna 340 and the first FEM 331 so that the signal output from the first FEM 331 is transferred to the antenna 340 (or antenna port 419) by reducing the loss of the signal transferred through a path between the antenna 340 and the first FEM 331 when the communication circuit 330 operates in the second operation mode. The third matching circuit 413 may perform impedance matching between the antenna 340 and the first FEM 331 so that the signal received by the antenna 340 is transferred to the first FEM 331 when the communication circuit 330 operates in the second operation mode.

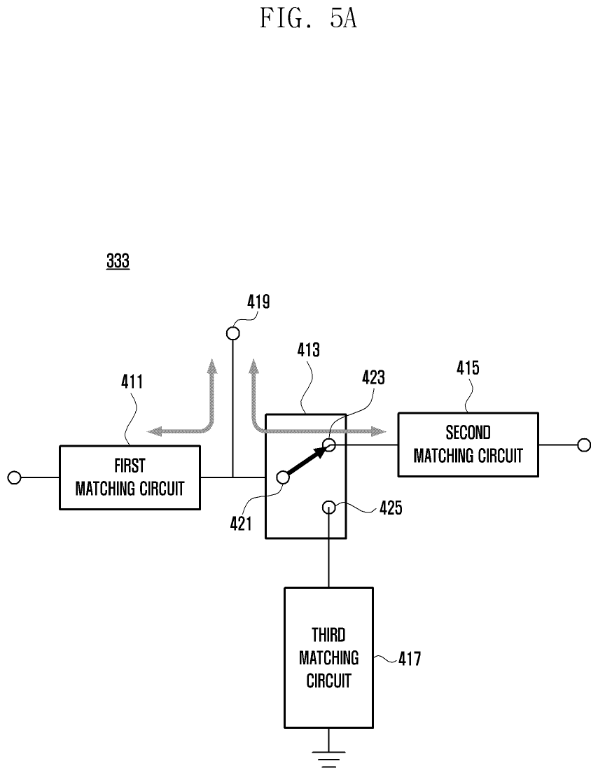

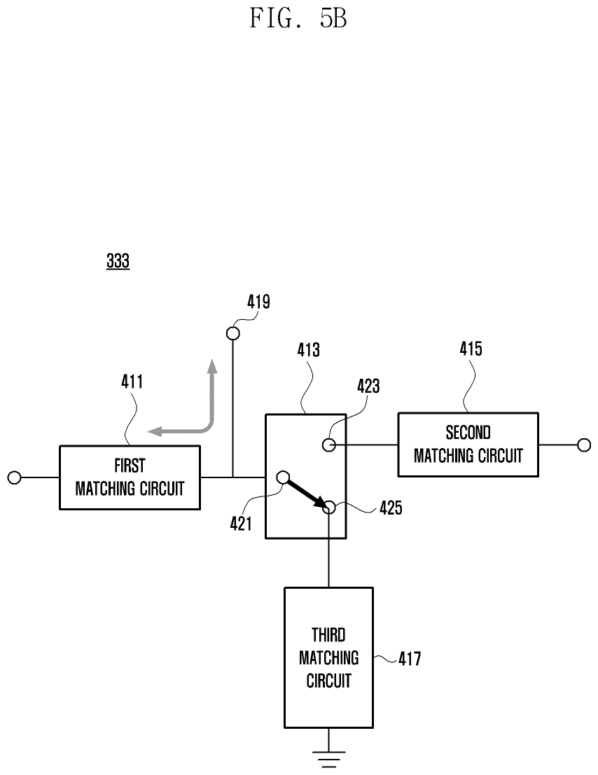

FIGS. 5A and 5B are diagrams depicting operations of the switch for first operation mode and second operation mode in the communication circuit of the electronic device according to various embodiments of the disclosure.

FIG. 5A is a diagram illustrating an embodiment in which the frequency branch circuit (e.g., frequency branch circuit 333 in FIG. 4) of the communication circuit (e.g., communication circuit 330 in FIG. 3) operates in the first operation mode.

The communication processor (e.g., communication processor 310 in FIG. 3) may operate in the first operation mode based on control data received from the base station. The first operation mode may be an operation mode in which a signal of the first frequency band and a signal of the second frequency band can be simultaneously transmitted or received. A signal of the first frequency band may be processed by the first FEM 331, and a signal of the second frequency band may be processed by the second FEM 335.

The communication processor 310 may operate in the first operation mode based on control data received from the base station. As the communication processor 310 operates in the first operation mode, it may control the switch 413 to electrically connect the first terminal 421 and the second terminal 423. When the first terminal 421 and the second terminal 423 are electrically connected, signals received by the antenna 340 may be transferred to the first FEM 331 and the second FEM 335. Some of the signals received by the antenna 340 may be transferred to the first FEM 331 through the first terminal 421, and some of the other signals received by the antenna 340 may be transferred to the second FEM 335 through the third terminal 425.

The first FEM 331 may receive signals, separate a signal of the first frequency band by using filters (e.g., plural filters 405 in FIG. 4), and transfer the separated signal of the first frequency band to the transceiver (e.g., transceiver 320 in FIG. 3). Among the signals received by the antenna 340, a signal not belonging to the first frequency band may be blocked by the plural filters 405.

The first FEM 331 may perform an operation of receiving a signal from the transceiver 320, amplifying the signal, or filtering the signal. The signal processed by the first FEM 331 (signal of the first frequency band) may be radiated through the antenna port 419 and the antenna 340.

The second FEM 335 may receive signals, separate a signal of the second frequency band by using filters (e.g., plural filters 435 in FIG. 4), and transfer the separated signal of the second frequency band to the transceiver 320. Among the signals received by the antenna 340, a signal not belonging to the second frequency band may be blocked by the plural filters 435.

The second FEM 335 may perform a processing operation of receiving a signal from the transceiver 320, amplifying the signal, or changing the phase. The signal processed by the second FEM 335 (signal of the second frequency band) may be radiated through the second terminal 423, the antenna port 419, and the antenna 340.

FIGS. 5A and 5B are diagrams depicting operations of the switch for first operation mode and second operation mode in the communication circuit of the electronic device according to various embodiments of the disclosure.

FIG. 5A is a diagram illustrating an embodiment in which the frequency selective circuit (e.g., frequency selective circuit 333 in FIG. 4) of the communication circuit (e.g., communication circuit 330 in FIG. 3) operates in the first operation mode.

The communication processor (e.g., communication processor 310 in FIG. 3) may operate in the first operation mode based on control data received from the base station. The first operation mode may be an operation mode in which a signal of the first frequency band and a signal of the second frequency band can be simultaneously transmitted or received. A signal of the first frequency band may be processed by the first FEM 331, and a signal of the second frequency band may be processed by the second FEM 335.

The communication processor 310 may operate in the first operation mode based on control data received from the base station. As the communication processor 310 operates in the first operation mode, it may control the switch 413 to electrically connect the first terminal 421 and the second terminal 423. When the first terminal 421 and the second terminal 423 are electrically connected, signals received by the antenna 340 may be transferred to the first FEM 331 and the second FEM 335. Some of the signals received by the antenna 340 may be transferred to the first FEM 331 through the first terminal 421, and some of the other signals received by the antenna 340 may be transferred to the second FEM 335 through the third terminal 425.

The first FEM 331 may receive signals, separate a signal of the first frequency band by using filters (e.g., plural filters 405 in FIG. 4), and transfer the separated signal of the first frequency band to the transceiver (e.g., transceiver 320 in FIG. 3). Among the signals received by the antenna 340, a signal not belonging to the first frequency band may be blocked by the plural filters 405.

The first FEM 331 may perform an operation of receiving a signal from the transceiver 320, amplifying the signal, or filtering the signal. The signal processed by the first FEM 331 (signal of the first frequency band) may be radiated through the antenna port 419 and the antenna 340.

The second FEM 335 may receive signals, separate a signal of the second frequency band by using filters (e.g., plural filters 435 in FIG. 4), and transfer the separated signal of the second frequency band to the transceiver 320. Among the signals received by the antenna 340, a signal not belonging to the second frequency band may be blocked by the plural filters 435.

The second FEM 335 may perform a processing operation of receiving a signal from the transceiver 320, amplifying the signal, or changing the phase. The signal processed by the second FEM 335 (signal of the second frequency band) may be radiated through the second terminal 423, the antenna port 419, and the antenna 340.

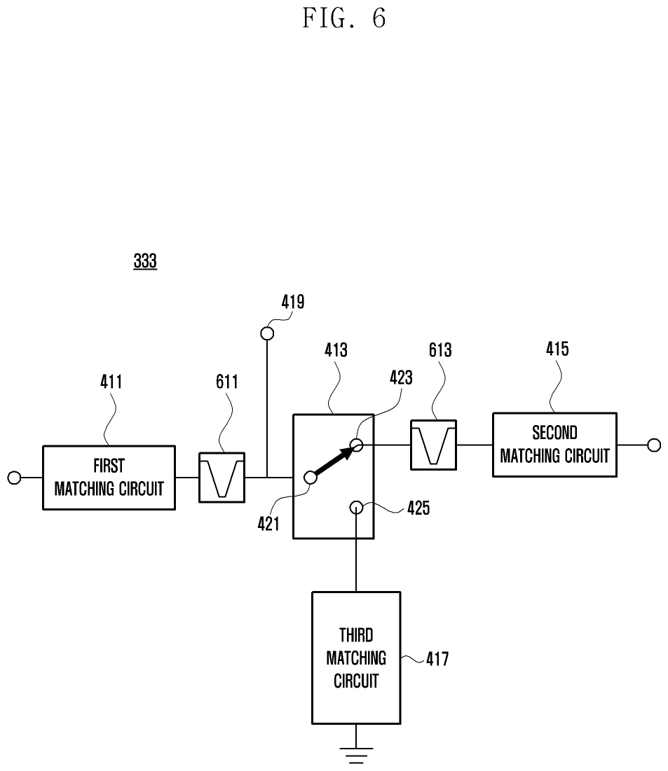

FIG. 6 is a diagram illustrating a communication circuit of the electronic device according to various embodiments of the disclosure.

The frequency selective circuit (e.g., frequency selective circuit 333 in FIG. 3) according to various embodiments of the disclosure may further include a first filter 611 that blocks a signal of the second frequency band and/or a second filter 613 that blocks a signal of the first frequency band.

The first filter 611 may be implemented with a band reject filter that blocks a signal of the second frequency band or a band pass filter that passes a signal of the first frequency band. The first filter 611 may block a signal of the second frequency band among the signals received by the antenna 340, and may increase isolation between the first FEM 331 and the second FEM 335. Although the first filter 611 is shown in FIG. 6 as being connected between the first matching circuit 411 and the first terminal 421, the first filter 611 may be connected between the first FEM (e.g., first FEM 331 in FIG. 3) and the first matching circuit 411.

The second filter 613 may be implemented with a band reject filter that blocks a signal of the first frequency band or a band pass filter that passes a signal of the second frequency band. The second filter 613 may block a signal of the first frequency band among the signals received by the antenna 340, and may increase isolation between the first FEM 331 and the second FEM 335. Although the second filter 613 is shown in FIG. 6 as being connected between the second matching circuit 415 and the second terminal 423, the second filter 613 may be connected between the second FEM (e.g., second FEM 335 in FIG. 3) and the second matching circuit 415.

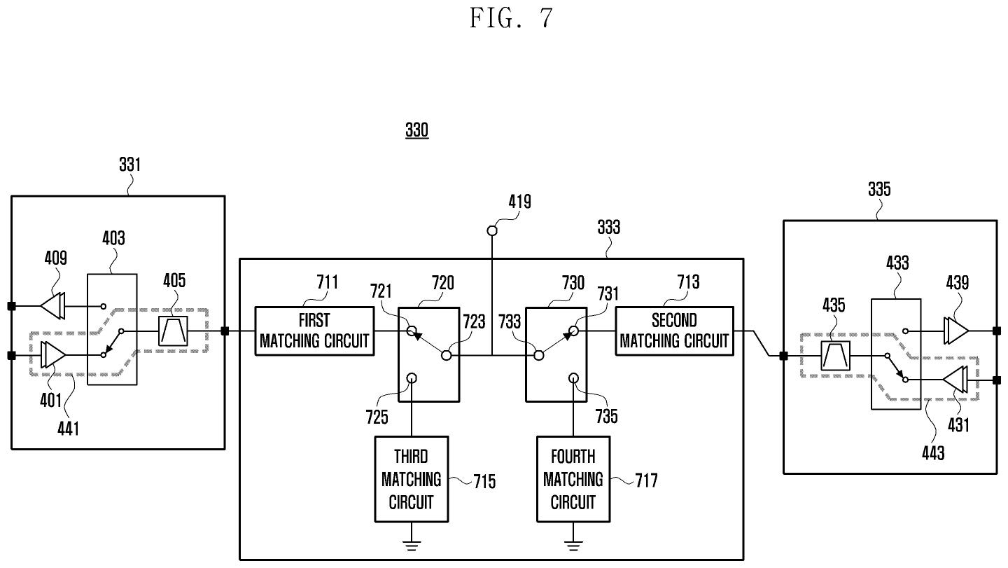

FIG. 7 is a diagram illustrating a communication circuit of the electronic device according to various embodiments of the disclosure.

The communication circuit 330 (e.g., communication circuit 330 in FIG. 3) according to various embodiments of the disclosure may include a first FEM 331, a frequency selective circuit 333, and/or a second FEM 335.

The first FEM 331 may amplify and filter a signal of the first frequency band to be output through the antenna (e.g., antenna 340 in FIG. 3), or may amplify and filter a signal of the first frequency band received through the antenna 340. The first FEM 331 may include a first amplifier 401 for amplifying a signal received from the transceiver (e.g., transceiver 320 in FIG. 3), a switch 403 for transferring the amplified signal to a filter 405, the filter 405 that passes a signal of a specific frequency band, and/or a third amplifier 409 for amplifying a signal of the first frequency band received through the antenna 340. The third amplifier 409 may be implemented with a low-noise amplifier.

In FIG. 7, although one RF chain (e.g., first RF chain 441) is shown, the number of RF chains may be varied according to the number of frequency bands supported by the first FEM 331. When the number of frequency bands supported by the first FEM 331 is plural, a switch may be implemented between one of the plural RF chains and the frequency branch circuit 333.

The first FEM 331 may perform an operation under the control of the communication processor (e.g., communication processor 310 in FIG. 3). The communication processor 310 may control the switch 403 so that the filter 405 corresponding to the frequency band in use is connected to the first amplifier 401. The communication processor 310 may control the switch 413 so that the filter 405 corresponding to the frequency band in use is connected to the frequency selective circuit 333. The first FEM 331 may process a signal transferred by the transceiver 320 and radiate the processed signal through the antenna 340 electrically connected to the antenna port 419.

According to various embodiments of the disclosure, the first FEM 331 may include a first RF chain 441 capable of transferring a signal of the first frequency band. The first RF chain 441 may include one or more components (e.g., amplifier 401, switch 403, filter 405) for transferring a signal of the first frequency band.

The second FEM 335 may amplify and filter a signal of the second frequency band to be output through the antenna (e.g., antenna 340 in FIG. 3), or may amplify and filter a signal of the second frequency band received through the antenna 340. The second FEM 335 may include a second amplifier 431 for amplifying a signal received from the transceiver (e.g., transceiver 320 in FIG. 3), a switch 433 for transferring the amplified signal to a filter 435, the filter 435 that passes a signal of a specific frequency band, and/or a fourth amplifier 439 for amplifying a signal of the second frequency band received through the antenna 340. The fourth amplifier 439 may be implemented with a low-noise amplifier (LNA).

In FIG. 7, although one RF chain (e.g., second RF chain 443) is shown, the number of RF chains may be varied according to the number of frequency bands supported by the second FEM 335. When the number of frequency bands supported by the second FEM 335 is plural, a switch connecting one of plural RF chains and the frequency branch circuit 333 may be implemented.

The second FEM 335 may include a second RF chain 443 capable of transferring a signal of the second frequency band. The second RF chain 443 may include one or more components (e.g., amplifier 431, switch 433, filter 435) for transferring a signal of the second frequency band.

The frequency branch circuit 333 may include at least two switches (e.g., first switch 720, second switch 730) that control paths of a signal of the first frequency band and a signal of the second frequency band. The first switch 720 may include a first terminal 721 electrically connected to the first FEM 331, a second terminal 723 electrically connected to the antenna port 419, and a third terminal 725 electrically connected to the ground. The second switch 730 may include a fourth terminal 731 electrically connected to the second FEM 335, a fifth terminal 733 electrically connected to the antenna port 419, and a sixth terminal 735 electrically connected to the ground. The second terminal 723 and the fifth terminal 733 may be electrically connected.

The communication processor 310 may support at least three operation modes. The communication processor 310 may support a first operation mode in which a signal of the first frequency band and a signal of the second frequency band can be simultaneously transmitted or received, a second operation mode in which a signal of the first frequency band can be transmitted or received, and a third operation mode in which a signal of the second frequency band can be transmitted or received. The communication processor 310 may select one of the first operation mode, the second operation mode and the third operation mode based on control data received from the base station (not shown), and control the first switch 720 and/or the second switch 730 according to the selected operation mode.

The communication processor 310 may operate in the first operation mode based on control data received from the base station. As the communication processor 310 operates in the first operation mode, it may control the first switch 720 to electrically connect the first terminal 721 and the second terminal 723 and control the second switch 730 to electrically connect the fourth terminal 731 and the fifth terminal 733. When the first terminal 721 and the second terminal 723 are electrically connected and the fourth terminal 731 and the fifth terminal 733 are electrically connected, signals received by the antenna 340 may be transferred to the first FEM 331 and the second FEM 335. Some of the signals received by the antenna 340 may be transferred to the plural filters 405 through the switch 413, and a signal corresponding to the first frequency band among the signals received by the antenna 340 may be transferred to the transceiver 320 through the plural filters 405, the switch 403, and the third amplifier 409. Among the signals received by the antenna 340, a signal not belonging to the first frequency band may be blocked by the plural filters 405. Some of the other signals received by the antenna 340 may be transferred to the second FEM 335 through the switch 413. Among some of the other signals received by the antenna 340, a signal of the second frequency band may be transferred to the transceiver 320 through the second FEM 335, and a signal not belonging to the second frequency band may be blocked by the second FEM 335.

The communication processor 310 may operate in the second operation mode based on control data received from the base station. As the communication processor 310 operates in the second operation mode, it may control the first switch 720 to electrically connect the first terminal 721 and the second terminal 723 and control the second switch 730 to electrically connect the fifth terminal 733 and the sixth terminal 735. When the first terminal 721 and the second terminal 723 are electrically connected and the fifth terminal 733 and the sixth terminal 735 are electrically connected, the signal received by the antenna 340 may be transferred to the first FEM 331. Some of the signals received by the antenna 340 may be transferred to the plural filters 405 through the switch 413, and a signal corresponding to the first frequency band among the signals received by the antenna 340 may be transferred to the transceiver 320 through the plural filters 405, the switch 403, and the third amplifier 409. In the second operation mode, the second switch 730 may be in a state where the fourth terminal 731 and the fifth terminal 733 are not connected to each other. In this case, a signal of the second frequency band may be not transferred to the transceiver 320.

The communication processor 310 may operate in the third operation mode based on control data received from the base station. As the communication processor 310 operates in the third operation mode, it may control the first switch 720 to electrically connect the third terminal 725 and the second terminal 723 and control the second switch 730 to electrically connect the fourth terminal 731 and the fifth terminal 733. When the second terminal 723 and the third terminal 725 are electrically connected and the fourth terminal 731 and the fifth terminal 733 are electrically connected, the signal received by the antenna 340 may be transferred to the second FEM 335. Among the signals received by the antenna 340, a signal of the second frequency band may be filtered by the second FEM 335 and transferred to the transceiver 320.

In the third operation mode, the first switch 720 may be in a state where the first terminal 721 and the second terminal 723 are not connected to each other. In this case, a signal of the first frequency band may be not transferred to the transceiver 320.

The frequency selective circuit 333 may include a first matching circuit 711 performing impedance matching between the antenna (e.g., antenna 340) and the first FEM 331, a second matching circuit 415 performing impedance matching between the antenna 340 and the second FEM 335, a third matching circuit 715, and/or a fourth matching circuit 717.

The third matching circuit 715 may be electrically connected between the third terminal 725 and the ground. The third matching circuit 715 may be a circuit that performs impedance matching for the second frequency band when the communication circuit 330 operates in the third mode of operation. The third matching circuit 715 may perform impedance matching so that the signal output from the second FEM 335 is transferred to the antenna 340 or the antenna port 419 while reducing the loss of the signal transferred through a path between the antenna 340 and the second FEM 335 when the communication circuit 330 operates in the third operation mode.

The fourth matching circuit 717 may be electrically connected between the sixth terminal 735 and the ground. The fourth matching circuit 717 may be a circuit that performs impedance matching when the communication circuit 330 operates in the second operation mode. The fourth matching circuit 717 may perform impedance matching so that the signal output from the first FEM 331 is transferred to the antenna 340 or the antenna port 419 by reducing the loss of the signal transferred through a path between the antenna 340 and the first FEM 331 when the communication circuit 330 operates in the second operation mode.

The second FEM 335 may perform an operation under the control of the communication processor (e.g., communication processor 310 in FIG. 3). The communication processor 310 may control the switch 433 so that the filter 435 is connected to the second amplifier 431 or the fourth amplifier 439 based on a transmission operation or reception operation. When the second FEM 335 implements plural RF chains (e.g., second RF chain 443), the communication processor 310 may control the switch 413 to connect an RF chain (e.g., second RF chain 443) corresponding to the frequency band in use and the frequency branch circuit 333. The second FEM 335 may process a signal transferred by the transceiver 320 and radiate the processed signal through the second switch 730, the antenna port 419 and the antenna 340. In this case, the second switch 730 of the frequency branch circuit 333 may be in a state where the fourth terminal 731 and the fifth terminal 733 are electrically connected, and the communication circuit 330 may be operating in the first operation mode or the third operation mode.

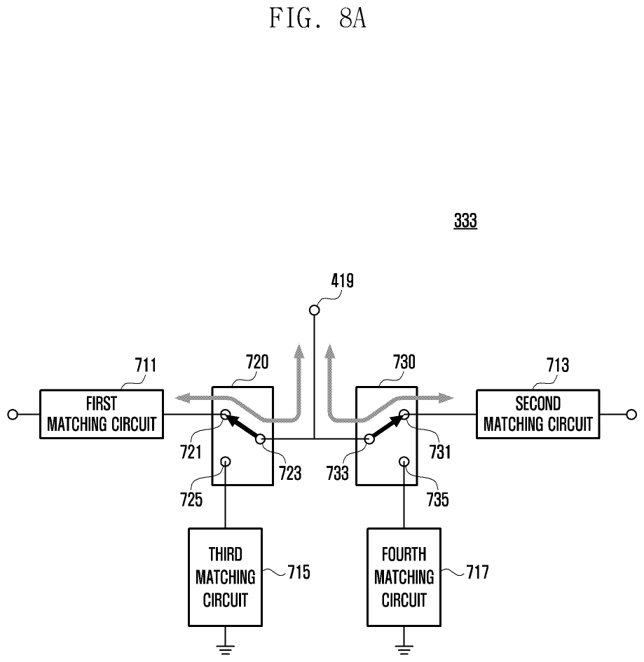

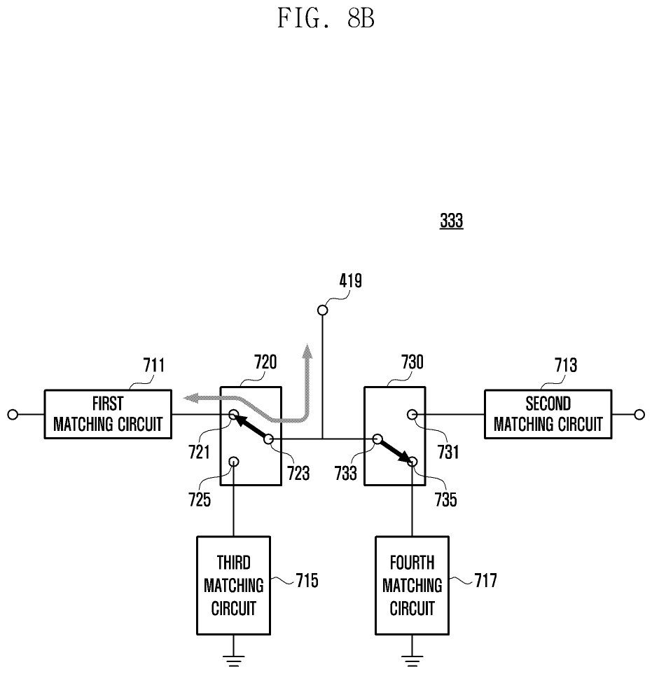

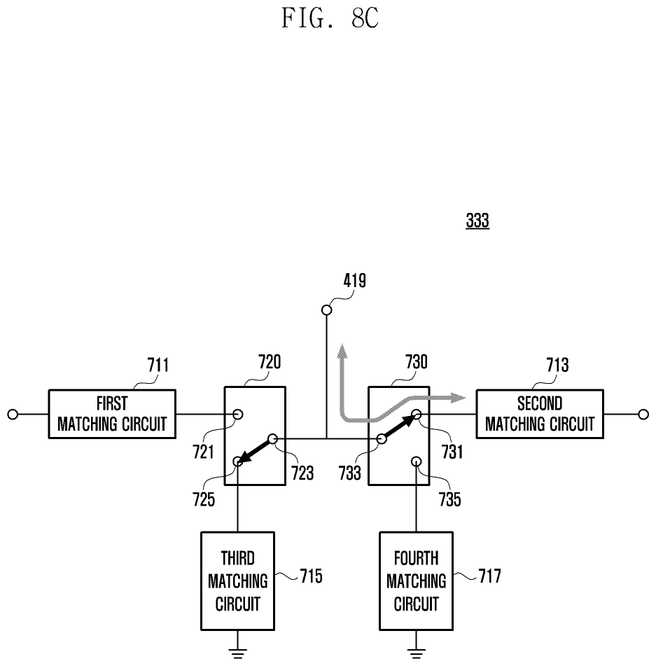

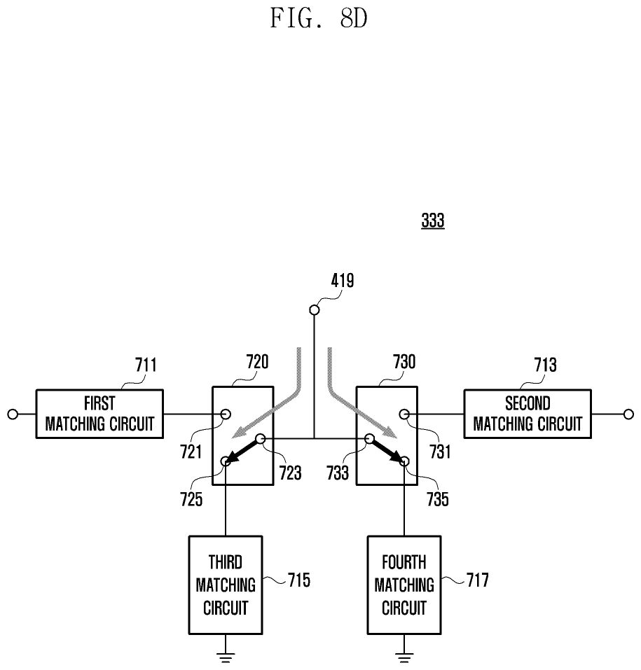

FIGS. 8A, 8B, 8C and 8D are diagrams depicting operations of the switch for first operation mode, second operation mode, third operation mode, and fourth operation mode in the communication circuit of the electronic device according to various embodiments of the disclosure.

FIG. 8A is a diagram illustrating an embodiment in which the frequency branch circuit (e.g., frequency branch circuit 333 in FIG. 7) of the communication circuit (e.g., communication circuit 330 in FIG. 3) operates in the first operation mode.

The communication processor (e.g., communication processor 310 in FIG. 3) may operate in the first operation mode based on control data received from the base station. The first operation mode may be an operation mode in which a signal of the first frequency band and a signal of the second frequency band can be simultaneously transmitted or received. A signal of the first frequency band may be processed by the first FEM 331, and a signal of the second frequency band may be processed by the second FEM 335.

As the communication processor 310 operates in the first operation mode, it may control the first switch 720 to electrically connect the first terminal 721 and the second terminal 723 and control the second switch 730 to electrically connect the fourth terminal 731 and the fifth terminal 733. When the first terminal 721 and the second terminal 723 are electrically connected and the fourth terminal 731 and the fifth terminal 733 are electrically connected, signals received by the antenna 340 may be transferred to the first FEM 331 and the second FEM 335. Among the signals received by the antenna 340, a signal corresponding to the first frequency band may be transferred to the transceiver 320 through the first FEM 331. Among the signals received by the antenna 340, a signal not belonging to the first frequency band may be blocked by the filter (e.g., plural filters 405 in FIG. 7) included in the first FEM 331. Some of the other signals received by the antenna 340 may be transferred to the second FEM 335 through the switch 413. Among some of the other signals received by the antenna 340, a signal of the second frequency band may be transferred to the transceiver 320 through the second FEM 335, and a signal not belonging to the second frequency band may be blocked by the second FEM 335.

A signal of the first frequency band transferred by the transceiver 320 to the first FEM 331 may be radiated through the antenna 340. Among the signals of the first frequency band transferred by the transceiver 320 to the first FEM 331, a signal transferred to the second FEM 335 through the fifth terminal 733 may be blocked by the filter (e.g., filter 435 in FIG. 4). As another example, a signal of the second frequency band transferred by the transceiver 320 to the second FEM 335 may be radiated through the antenna 340. Among the signals of the second frequency band transferred by the transceiver 320 to the second FEM 335, a signal transferred to the first FEM 331 through the third terminal 723 may be blocked by the filter (e.g., filter 405 in FIG. 4).

FIG. 8B is a diagram illustrating an embodiment in which the frequency branch circuit (e.g., frequency branch circuit 333 in FIG. 7) of the communication circuit (e.g., communication circuit 330 in FIG. 3) operates in the second operation mode.

The communication processor 310 may operate in the second operation mode based on control data received from the base station. As the communication processor 310 operates in the second operation mode, it may control the first switch 720 to electrically connect the first terminal 721 and the second terminal 723 and control the second switch 730 to electrically connect the fifth terminal 733 and the sixth terminal 735. When the first terminal 721 and the second terminal 723 are electrically connected and the fifth terminal 733 and the sixth terminal 735 are electrically connected, the signal received by the antenna 340 may be transferred to the first FEM 331. Some of the signals received by the antenna 340 may be transferred to the transceiver 320 through the first FEM 331. In the second operation mode, the second switch 730 may be in a state where the fourth terminal 731 and the fifth terminal 733 are not connected to each other. In this case, a signal of the second frequency band may be not transferred to the transceiver 320.

The signal of the first frequency band transferred by the transceiver 320 to the first FEM 331 may be radiated through the antenna 340. Among the signals of the first frequency band transferred by the transceiver 320 to the first FEM 331, a signal transferred to the second FEM 335 through the fifth terminal 733 may be blocked by the filter (e.g., filter 405 in FIG. 4).

FIG. 8C is a diagram illustrating an embodiment in which the frequency branch circuit (e.g., frequency branch circuit 333 in FIG. 7) of the communication circuit (e.g., communication circuit 330 in FIG. 3) operates in the third operation mode.

The communication processor 310 may operate in the third operation mode based on control data received from the base station. As the communication processor 310 operates in the third operation mode, it may control the first switch 720 to electrically connect the third terminal 725 and the second terminal 723 and control the second switch 730 to electrically connect the fourth terminal 731 and the fifth terminal 733. When the second terminal 723 and the third terminal 725 are electrically connected and the fourth terminal 731 and the fifth terminal 733 are electrically connected, the signal received by the antenna 340 may be transferred to the second FEM 335. Among the signals received by the antenna 340, a signal of the second frequency band may be filtered by the second FEM 335 and transferred to the transceiver 320.

In the third operation mode, the first switch 720 may be in a state where the first terminal 721 and the second terminal 723 are not connected to each other. In this case, a signal of the first frequency band may be not transferred to the transceiver 320.

A signal of the second frequency band transferred by the transceiver 320 to the second FEM 335 may be radiated through the antenna 340. Among the signals of the second frequency band transferred by the transceiver 320 to the second FEM 335, a signal transferred to the first FEM 331 through the third terminal 723 may be blocked by the filter (e.g., filter 405 in FIG. 4).

FIG. 8D is a diagram illustrating an embodiment in which the frequency selective circuit (e.g., frequency selective circuit 333 in FIG. 7) of the communication circuit (e.g., communication circuit 330 in FIG. 3) operates in the fourth operation mode.

The fourth operation mode may be a mode in which neither a signal of the first frequency band nor a signal of the second frequency band can be received or transmitted. In the fourth operating mode, the communication circuit 330 may switch the first FEM 331 and the second FEM 335 to an inactive state, reducing the power consumed by the communication circuit 330.

The communication processor 310 may operate in the fourth operation mode based on the state (e.g., there is no data to be transmitted or received by the electronic device 101) of the electronic device (e.g., electronic device 101 in FIG. 1). As the communication processor 310 operates in the fourth operation mode, it may control the first switch 720 to electrically connect the second terminal 723 and the third terminal 725 and control the second switch 730 to electrically connect the fifth terminal 733 and the sixth terminal 735. When the second terminal 723 and the third terminal 725 are electrically connected and the fifth terminal 733 and the sixth terminal 735 are electrically connected, the signal received by the antenna 340 may be not transferred to the first FEM 331 and the second FEM 335.

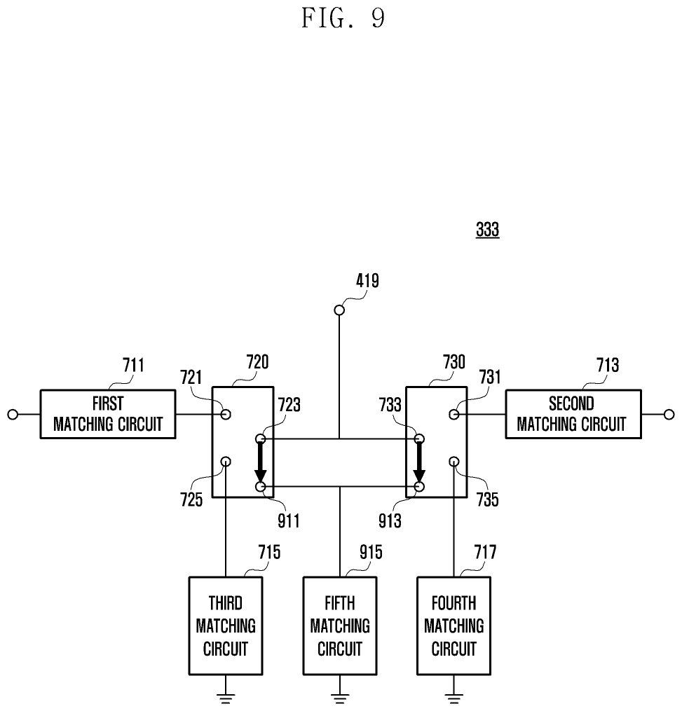

FIG. 9 is a diagram depicting operations of the switch for fourth operation mode in the communication circuit of the electronic device according to various embodiments of the disclosure.

With reference to FIG. 9, the first switch (e.g., first switch 720 in FIG. 7) of the frequency selective circuit (e.g., frequency selective circuit 333 in FIG. 7) may further include a seventh terminal 911 electrically connected to the ground. The second switch (e.g., second switch 730 in FIG. 7) may further include an eighth terminal 913 electrically connected to the ground. The seventh terminal 911 and the eighth terminal 913 may be electrically connected.

The communication processor 310 may operate in a fifth operation mode that is similar to the the fourth operation mode based on the state (e.g., there is no data to be transmitted or received by the electronic device 101) of the electronic device (e.g., electronic device 101 in FIG. 1). As the communication processor 310 operates in the fifth operation mode, it may control the first switch 720 to electrically connect the second terminal 723 and the seventh terminal 911 and control the second switch 730 to electrically connect the fifth terminal 733 and the eighth terminal 913. When the second terminal 723 and the seventh terminal 911 are electrically connected and the fifth terminal 733 and the eighth terminal 913 are electrically connected, the signal received by the antenna 340 may be not transferred to the first FEM 331 and the second FEM 335.

The seventh terminal 911 and/or the eighth terminal 913 may be electrically connected to the same ground. A fifth matching circuit 915 may be included between the seventh terminal 911 and/or the eighth terminal 913 and the ground. In a state where the first terminal 721 and the second terminal 723 are not connected to each other and the fourth terminal 731 and the fifth terminal 733 are not connected to each other, the signal received by the antenna 340 may be not transferred to the first FEM 331 and/or the second FEM 335. When the communication circuit 330 operates in the fifth operation mode, the fifth matching circuit 915 may prevent the signal received by the antenna 340 from being transferred to the first FEM 331 and/or the second FEM 335.

A communication circuit (e.g., communication circuit 330 in FIG. 3) may include: a first RF chain (e.g., first RF chain 441 in FIG. 4) that outputs a signal of a first frequency band through an antenna port (e.g., antenna port 419 in FIG. 4) or receives a signal of the first frequency band through the antenna port 419; a second RF chain (e.g., second RF chain 443 in FIG. 4) that outputs a signal of a second frequency band through the antenna port 419 or receives a signal of the second frequency band through the antenna port 419; and a switch (e.g., switch 413 in FIG. 4) including a first terminal (e.g., first terminal 421 in FIG. 4) electrically connected to the first RF chain 441, a second terminal (e.g., second terminal 423 in FIG. 4) connected to the second RF chain 443, and a third terminal (e.g., third terminal 425 in FIG. 4) electrically connected to the ground, wherein the switch 413 may be set to operate in one operation mode among a first operation mode where the first terminal 421 and the second terminal 423 are electrically connected and a second operation mode where the first terminal 421 and the third terminal 425 are electrically connected.

In the communication circuit 330, the first operation mode may be an operation mode where a signal of the first frequency band and a signal of the second frequency band can be simultaneously transmitted or received.

In the communication circuit 330, the second operation mode may be an operation mode where a signal of the first frequency band can be transmitted or received.

The communication circuit 330 may further include a matching circuit (e.g., third matching circuit 417 in FIG. 4) electrically connected between the third terminal 425 and the ground, wherein the matching circuit 417 may be implemented so that a signal to be transmitted or received through the first RF chain 441 is not transferred to the second terminal or the third terminal in the first operation mode.

The communication circuit 330 may further include a first filter (e.g., first matching circuit 411 in FIG. 4) for blocking a signal of the second frequency band, wherein the first filter 411 may be electrically connected between the first RF chain 441 and the antenna port 419.

The communication circuit 330 may further include a second filter (e.g., second matching circuit 415 in FIG. 4) for blocking a signal of the first frequency band, wherein the second filter 415 may be electrically connected between the second RF chain 443 and the switch 413.

A communication circuit (e.g., communication circuit 330 in FIG. 7) may include: a first RF chain (e.g., first RF chain 441 in FIG. 7) that outputs a signal of a first frequency band through an antenna port (e.g., antenna port 419 in FIG. 7) or receives a signal of the first frequency band through the antenna port 419; a second RF chain (e.g., second RF chain 443 in FIG. 7) that outputs a signal of a second frequency band through the antenna port 419 or receives a signal of the second frequency band through the antenna port 419; a first switch (e.g., first switch 720 in FIG. 7) including a first terminal (e.g., first terminal 721 in FIG. 7) electrically connected to the first RF chain 441, a second terminal (e.g., second terminal 723 in FIG. 7) electrically connected to the antenna port 419, and a third terminal (e.g., third terminal 725 in FIG. 7) electrically connected to the ground; and a second switch (e.g., second switch 730 in FIG. 7) including a fourth terminal (e.g., fourth terminal 731 in FIG. 7) electrically connected to the second RF chain 443, a fifth terminal (e.g., fifth terminal 733 in FIG. 7) connected to the antenna port 419, and a sixth terminal (e.g., sixth terminal 735 in FIG. 7) electrically connected to the ground, wherein the communication circuit may be configured to operate in one operation mode among a first operation mode where the first terminal 721 and the second terminal 723 are electrically connected and the fourth terminal 731 and the fifth terminal 733 are electrically connected, a second operation mode where the first terminal 721 and the second terminal 723 are electrically connected and the fifth terminal 733 and the sixth terminal 735 are electrically connected, and a third operation mode where the second terminal 723 and the third terminal 725 are electrically connected and the fourth terminal 731 and the fifth terminal 733 are electrically connected.

In the communication circuit 330, the first operation mode may be an operation mode where a signal of the first frequency band and a signal of the second frequency band can be simultaneously transmitted or received through the antenna port 419.

In the communication circuit 330, the second operation mode may be an operation mode where a signal of the first frequency band can be transmitted or received through the antenna port 419.

In the communication circuit 330, the third operation mode may be an operation mode where a signal of the second frequency band can be transmitted or received through the antenna port 419.

The communication circuit 330 may further include a first matching circuit (e.g., third matching circuit 715) electrically connected between the third terminal 725 and the ground, wherein the first matching circuit 715 may be implemented so that a signal to be transmitted or received through the second RF chain 443 is not transferred to the first terminal 721 or the third terminal 725 in the third operation mode.

The communication circuit 330 may further include a second matching circuit (e.g., fourth matching circuit 717 in FIG. 7) electrically connected between the sixth terminal 735 and the ground, wherein the second matching circuit 717 may be implemented so that a signal to be transmitted or received through the first RF chain 441 is not transferred to the fourth terminal 731 or the sixth terminal 735 in the second operation mode.

The communication circuit 330 may be configured to operate in a fourth operation mode where the second terminal 723 and the third terminal 725 are electrically connected and the fifth terminal 733 and the sixth terminal 735 are electrically connected, wherein the fourth operation mode may be a mode where no signal is transmitted or received through the antenna port 419.

In the communication circuit 330, the first switch 720 may further include a seventh terminal (e.g., seventh terminal 911 in FIG. 9) electrically connected to the ground, the second switch 730 may further include an eighth terminal (e.g., eighth terminal 913 in FIG. 9) electrically connected to the ground, and the communication circuit 330 may be configured to operate in the fourth operation mode in a manner of electrically connecting the second terminal 723 and the seventh terminal 911 and electrically connecting the fifth terminal 733 and the eighth terminal 913.

An electronic device (e.g., electronic device 101 in FIG. 1) may include: a communication processor (e.g., communication processor 310 in FIG. 3); a transceiver (e.g., transceiver 320 in FIG. 3), and a communication circuit (e.g., communication circuit 330 in FIG. 3), wherein the communication circuit 330 may include a first RF chain (e.g., first RF chain 441 in FIG. 4) that outputs a signal of a first frequency band through an antenna port (e.g., antenna port 419 in FIG. 4) or receives a signal of the first frequency band through the antenna port 419, a second RF chain (e.g., second RF chain 443 in FIG. 4) that outputs a signal of a second frequency band through the antenna port 419 or receives a signal of the second frequency band through the antenna port 419, and a switch (e.g., switch 413 in FIG. 4) including a first terminal (e.g., first terminal 421 in FIG. 4) electrically connected to the first RF chain 441, a second terminal (e.g., second terminal 423 in FIG. 4) connected to the second RF chain 443, and a third terminal (e.g., third terminal 425 in FIG. 4) electrically connected to the ground, and wherein the communication processor 310 may be configured to control the switch 413 to electrically connect the first terminal 421 and the second terminal 423 when operating in a first operation mode where a signal of the first frequency band and a signal of the second frequency band are simultaneously transmitted or received, and control the switch 413 to electrically connect the first terminal 421 and the third terminal 425 when operating in a second operation mode where a signal of the first frequency band is transmitted or received.

In the electronic device 101, the communication circuit 330 may further include a matching circuit (e.g., third matching circuit 417 in FIG. 4) electrically connected between the third terminal 425 and the ground, wherein the matching circuit 417 may be implemented so that a signal to be transmitted or received through the first RF chain 441 is not transferred to the second terminal 423 or the third terminal 425 in the first operation mode.

An electronic device (e.g., electronic device 101 in FIG. 1) may include: a communication processor (e.g., communication processor 310 in FIG. 3); a transceiver (e.g., transceiver 320 in FIG. 3), and a communication circuit (e.g., communication circuit 330 in FIG. 3), wherein the communication circuit 330 may include: a first RF chain (e.g., first RF chain 441 in FIG. 7) that outputs a signal of a first frequency band through an antenna port (e.g., antenna port 419 in FIG. 7) or receives a signal of the first frequency band through the antenna port 419; a second RF chain (e.g., second RF chain 443 in FIG. 7) that outputs a signal of a second frequency band through the antenna port 419 or receives a signal of the second frequency band through the antenna port 419; a first switch (e.g., first switch 720 in FIG. 7) including a first terminal (e.g., first terminal 721 in FIG. 7) electrically connected to the first RF chain 441, a second terminal (e.g., second terminal 723 in FIG. 7) electrically connected to the antenna port 419, and a third terminal (e.g., third terminal 725 in FIG. 7) electrically connected to the ground; and a second switch (e.g., second switch 730 in FIG. 7) including a fourth terminal (e.g., fourth terminal 731 in FIG. 7) electrically connected to the second RF chain 443, a fifth terminal (e.g., fifth terminal 733 in FIG. 7) connected to the antenna port 419, and a sixth terminal (e.g., sixth terminal 735 in FIG. 7) electrically connected to the ground, and wherein the communication processor 310 may be configured to: control the first switch 720 to electrically connect the first terminal 721 and the second terminal 723 and control the second switch 730 to electrically connect the fourth terminal 731 and the fifth terminal 733 when operating in a first operation mode where a signal of the first frequency band and a signal of the second frequency band are transmitted or received; control the first switch 720 to electrically connect the first terminal 721 and the second terminal 723 and control the second switch 730 to electrically connect the fifth terminal 733 and the sixth terminal 735 when operating in a second operation mode where a signal of the first frequency band is transmitted or received; and control the first switch 720 to electrically connect the second terminal 723 and the third terminal 725 and control the second switch 730 to electrically connect the fourth terminal 731 and the fifth terminal 733 when operating in a third operation mode where a signal of the second frequency band is transmitted or received.

In the electronic device 101, the communication circuit 330 may further include a first matching circuit (e.g., third matching circuit 715) electrically connected between the third terminal 725 and the ground, and/or a second matching circuit (e.g., fourth matching circuit 717 in FIG. 7) electrically connected between the sixth terminal 735 and the ground, wherein the first matching circuit 715 may be implemented so that a signal to be transmitted or received through the second RF chain 443 is not transferred to the first terminal 721 or the third terminal 725 in the third operation mode, and the second matching circuit 717 may be implemented so that a signal to be transmitted or received through the first RF chain 441 is not transferred to the fourth terminal 731 or the sixth terminal 735 in the second operation mode.

In the electronic device 101, the communication processor 310 may be configured to control the first switch 720 to electrically connect the second terminal 723 and the third terminal 725 and control the second switch 730 to electrically connect the fifth terminal 733 and the sixth terminal 735 when operating in a fourth operation mode where no signal is transmitted or received through the antenna port 419.

In the electronic device, the first switch 720 may further include a seventh terminal (e.g., seventh terminal 911 in FIG. 9) electrically connected to the ground; the second switch 730 may further include an eighth terminal (e.g., eighth terminal 913 in FIG. 9) electrically connected to the ground; and the communication processor 310 may be configured to control the first switch 720 to electrically connect the second terminal 723 and the seventh terminal 911 and control the second switch 730 to electrically connect the fifth terminal 733 and the eighth terminal 913 when operating in the fourth operation mode.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. A communication circuit comprising:
a first radio frequency (RF) chain configured to output and/or receive a signal of a first frequency band through an antenna port;
a second RF chain configured to output and/or receive a signal of a second frequency band through the antenna port; and
a switch comprising a first terminal electrically connected to the first RF chain, a second terminal electrically connected to the second RF chain, and a third terminal electrically connected to a ground,
wherein the switch is configured to operate in a first operation mode or a second operation mode,
wherein in the first operation mode, the first terminal is electrically connected to the second terminal, and
wherein in the second operation mode, the first terminal is electrically connected to the third terminal.

2. The communication circuit of claim 1, wherein the first operation mode is an operation mode where the signal of the first frequency band and the signal of the second frequency band can be simultaneously transmitted or received.

3. The communication circuit of claim 1, wherein the second operation mode is an operation mode where the signal of the first frequency band can be transmitted or received and the signal of the second frequency band cannot be transmitted or received.

4. The communication circuit of claim 1, further comprising a matching circuit electrically connected between the third terminal and the ground, the matching circuit being configured so as to prevent a signal to be transmitted or received through the first RF chain from being transferred to the second terminal or the third terminal in the first operation mode.

5. The communication circuit of claim 1, further comprising a first filter configured to block a signal of the second frequency band, the first filter being electrically connected between the first RF chain and the antenna port.

6. The communication circuit of claim 1, further comprising a second filter configured to block a signal of the first frequency band, the second filter being electrically connected between the second RF chain and the switch.

7. A communication circuit comprising:
a first radio frequency (RF) chain configured to output and/or receive a signal of a first frequency band through an antenna port;
a second RF chain configured to output and/or receive a signal of a second frequency band through the antenna port;
a first switch comprising a first terminal electrically connected to the first RF chain, a second terminal electrically connected to the antenna port, and a third terminal electrically connected to a ground; and
a second switch comprising a fourth terminal electrically connected to the second RF chain, a fifth terminal connected to the antenna port, and a sixth terminal electrically connected to the ground,
wherein the communication circuit is configured to operate in a first operation mode, a second operation mode, or a third operation mode,
wherein in the first operation mode, the first terminal is electrically connected to the second terminal and the fourth terminal is electrically connected to the fifth terminal,
wherein in the second operation mode, the first terminal is electrically connected to the second terminal and the fifth terminal is electrically connected to the sixth terminal, and
wherein in the third operation mode, the second terminal is electrically connected to the third terminal and the fourth terminal is electrically connected to the fifth terminal.

8. The communication circuit of claim 7, wherein the first operation mode is an operation mode where the signal of the first frequency band and the signal of the second frequency band can be simultaneously transmitted or received through the antenna port.

9. The communication circuit of claim 7, wherein the second operation mode is an operation mode where the signal of the first frequency band can be transmitted or received through the antenna port and the signal of the second frequency band cannot be transmitted or received through the antenna port.

10. The communication circuit of claim 7, wherein the third operation mode is an operation mode where a signal of the second frequency band can be transmitted or received through the antenna port and the signal of the first frequency band cannot be transmitted or received through the antenna port.

11. The communication circuit of claim 7, further comprising a first matching circuit electrically connected between the third terminal and the ground, the first matching circuit being configured so as to prevent a signal to be transmitted or received through the second RF chain from being transferred to the first terminal or the third terminal in the third operation mode.

12. The communication circuit of claim 7, further comprising a second matching circuit electrically connected between the sixth terminal and the ground, the second matching circuit being configured so as to prevent a signal to be transmitted or received through the first RF chain from being transferred to the fourth terminal or the sixth terminal in the second operation mode.

13. The communication circuit of claim 7,
wherein the communication circuit is configured to operate in the first operation mode, the second operation mode, the third operation mode, or a fourth operation mode,
wherein in the fourth operation mode, the second terminal is electrically connected to the third terminal and the fifth terminal is electrically connected to the sixth terminal, and
wherein the fourth operation mode is a mode where neither the signal of the first frequency band nor the signal of the second frequency band can be transmitted or received through the antenna port.

14. The communication circuit of claim 13,
wherein the first switch further comprises a seventh terminal electrically connected to the ground;
wherein the second switch further comprises an eighth terminal electrically connected to the ground;
wherein the communication circuit is configured to operate in the first operation mode, the second operation mode, the third operation mode, the fourth operation mode, or a fifth operation mode,
wherein in the fifth operation mode, the second terminal is electrically connected to the seventh terminal and the fifth terminal is electrically connected to the eighth terminal.

15. An electronic device comprising:
a communication processor;
a transceiver; and
a communication circuit,
wherein the communication circuit comprises:
a first radio frequency (RF) chain configured to output and/or receive a signal of a first frequency band through an antenna port,
a second RF chain configured to output and/or receive a signal of a second frequency band through the antenna port, and
a switch comprising a first terminal electrically connected to the first RF chain, a second terminal electrically connected to the second RF chain, and a third terminal electrically connected to a ground,
wherein the communication processor is configured to:
control the switch to electrically connect the first terminal to the second terminal in a first operation mode where the signal of the first frequency band and the signal of the second frequency band can be simultaneously transmitted or received, and
control the switch to electrically connect the first terminal to the third terminal in a second operation mode where the signal of the first frequency band can be transmitted or received and the signal of the second frequency band cannot be transmitted or received.

16. The communication circuit of claim 1,
wherein in the first operation mode, the first terminal is not electrically connected to the third terminal, and
wherein in the second operation mode, the first terminal is not electrically connected to the second terminal.

17. The communication circuit of claim 7,
wherein in the first operation mode, the second terminal is not electrically connected to the third terminal and the sixth terminal is not electrically connected to the fifth terminal,
wherein in the second operation mode, the second terminal is not electrically connected to the third terminal and the fifth terminal is not electrically connected to the fourth terminal, and
wherein in the third operation mode, the second terminal is not electrically connected to the first terminal and the sixth terminal is not electrically connected to the fifth terminal.

18. The communication circuit of claim 13, further comprising
a first matching circuit electrically connected between the third terminal and the ground, the first matching circuit being configured so as to prevent a signal to be transmitted or received through the second RF chain from being transferred to the first terminal or the third terminal in the third operation mode, and
a second matching circuit electrically connected between the sixth terminal and the ground, the second matching circuit being configured so as to prevent a signal to be transmitted or received through the first RF chain from being transferred to the fourth terminal or the sixth terminal in the second operation mode.

19. The communication circuit of claim 14, further comprising
a third matching circuit electrically connected between the third terminal and the ground and between the sixth terminal and the ground, the third matching circuit being configured so as (i) to prevent a signal to be transmitted or received through the second RF chain from being transferred to the first terminal or the third terminal in the third operation mode and (ii) to prevent a signal to be transmitted or received through the first RF chain from being transferred to the fourth terminal or the sixth terminal in the second operation mode.

20. The electronic device of claim 15,
wherein in the first operation mode, the first terminal is not electrically connected to the third terminal, and
wherein in the second operation mode, the first terminal is not electrically connected to the second terminal.
